(19) United States
(12) Patent Application Publication
(10) Pub. No.: US 2021/0394158 A1
(43) Pub. Date: Dec. 23, 2021

(54) Silica Alumina Composition with Improved Stability and Method for Making Same

(71) Applicant: Sasol (USA) Corporation, Houston, TX (US)

(72) Inventors: Maria Roberta RABAIOLI, Lake Charles, LA (US); Umesh CHAUDHARY, Lafayette, LA (US)

(21) Appl. No.: 17/292,070

(22) PCT Filed: Nov. 20, 2019
(86) PCT No.: PCT/US2019/062408

§ 371 Date: May 7, 2021

Related U.S. Application Data
(60) Provisional application No. 62/888,120, filed on Aug. 16, 2019.
(60) Provisional application No. 62/770,393, filed on Nov. 21, 2018.

(51) Int. Cl. B01J 21/12; B01J 35/10; B01J 37/02; B01J 37/10; B01J 37/08; B01J 35/02

(52) U.S. Cl. CPC B01J 21/12; B01J 35/1019; B01J 35/1042; B01J 35/023; B01J 37/10; B01J 37/082; B01J 37/0211

(57) ABSTRACT

The invention relates to a novel method of making a silica alumina including the use of two silica sources, the first silica source differing chemically from the second silica source, to a silica alumina made according to the method of the invention and to a silica alumina having improved characteristics.

### FIELD OF INVENTION

The invention relates to a novel method of making a silica alumina, to a silica alumina made according to the method of the invention, and to a silica alumina having improved characteristics.

### BACKGROUND

Silica alumina is used in the field of catalyst supports. Many prior art documents describe processes for the preparation of silica alumina and the focus is on obtaining a homogeneous distribution of silica on the alumina and/or obtaining high pore volume matrices. This can be done through mixing boehmite, for example, with an amorphous silica, for example, sodium silicate under specific conditions. The problems associated with such a preparation of the silica alumina include the introduction of impurities e.g. SiO₂ (quartz) in the final product as well as issues relating to a decrease in the surface area of the silica alumina.

U.S. Pat. No. 5,187,138 describes a hydroisomerisation catalyst supported on an alumina or an amorphous silica alumina support (modified with the addition of a silica as a surface modifying agent). The base silica and alumina materials used in this invention may be soluble silicon containing compounds such as alkali metal silicates, tetraalkoxysilane, or orthosilicic esters, sulfates, nitrates or chlorides of aluminum alkali metal aluminates or inorganic salts or alkoxides or the like. The process includes precipitation and aging, followed by filtering, drying and calcining to obtain the support material. The support material is then impregnated with a suitable silicon containing compound e.g. ethyl orthosilicate in an isopropanol carrier. Other sources of silicon include silanes, colloidal silica, silicon chlorides or other inorganic silicon salts. U.S. Pat. No. 5,187,138 explains that the silica used as a modifier is chemically similar to the silica in the bulk catalyst support. The use of the silica as a surface modifying agent improves the activity and the selectivity of the catalyst.

The process of the present invention aims to improve the characteristics of the final silica alumina product, in particular, a product having an enhanced thermal stability and purity.

### SUMMARY OF THE INVENTION

According to a first aspect of the invention, there is provided a method of making a silica alumina product including the following steps:
i) providing an alumina slurry;
ii) adding a first source of silica to the alumina slurry to form a silica alumina slurry;
iii) hydrothermally aging the silica alumina slurry to form a hydrothermally aged silica alumina slurry;
iv) drying the hydrothermally aged silica alumina slurry to form a dried aged silica alumina intermediate product;
v) calcining the dried aged silica alumina intermediate product to form a calcined dried aged silica alumina intermediate product;
vi) adding the calcined dried aged silica alumina intermediate product from step v) to a solution including a second source of silica, the second source of silica differing chemically from the first source of silica provided in step ii) to form a re-slurried silica alumina;
vii) drying the re-slurried silica alumina to form a dried re-slurried silica alumina; and
viii) calcining the dried re-slurried silica alumina to form the silica alumina product.

The alumina slurry includes alumina and at least water.

The alumina slurry preferably has a pH of between 8 and 10 and most preferably a pH of 9. Even more preferably the alumina slurry may be a slurry from a Ziegler process having a pH of between 8 and 10, more particularly in the region of 9.

The alumina is preferably boehmite. The alumina preferably includes particles having a crystallite size on the (120) plane of between 40 Å and 60 Å, preferably a crystallite size of the (120) plane of between 40 Å and 50 Å, more preferably a crystallite size on the (120) plane of about 45 Å.

The first source of silica includes a silica sol, a precipitated silica, or a fumed silica. The first source of silica may include a mixture of a silica sol, a precipitated silica or a fumed silica. The silica sol is preferably a colloidal silica sol.

When the first source of silica is in the form of a silica sol, the silica sol is preferably made up of silica particles having a particle size of about 40 Å to 50 Å. The silica sol preferably has a pH of between 8 and 10, preferably 9.

The first source of silica preferably includes a stable aqueous dispersion of silica particles e.g. a colloidal silica sol. The silica sol may be stabilized with a base, preferably a base including ammonia, e.g. an ammonium hydroxide solution.

The pH of the silica alumina slurry is between 6 and 9, preferably between 6 and 8, most preferably around 7.

The ratio of silica to alumina in the silica alumina slurry is between 1 and 7% by weight, preferably between 5 and 7% by weight.

The hydrothermal aging of step iii) of the process of the invention occurs at temperatures between 100° C. and 150° C., preferably at temperatures between 120° C. and 130° C., for a period of 3 to 6 hours. The temperature and time parameters are independently selected.

The hydrothermally aged silica alumina slurry is dried at a temperature of about 90 to 130° C., preferably at a temperature of between 100 and 105° C. using conventional technology (for example a spray dryer) to obtain a dried, aged silica alumina intermediate product. The dried aged silica alumina intermediate product is preferably a silica-boehmite intermediate product with a crystallite size of between 50 and 60 Å.

Calcination of the dried aged silica alumina intermediate product occurs at temperatures of between 300° C. and 600° C. for a period of 2 to 6 hours depending on the alumina source.

The second source of silica includes SiO₂, silicon alkoxide, silicon esters, and aqueous silicon compounds. The invention provides for mixtures of these sources of silica. The solution including the second source of silica in step vi) of the process of the invention may include an alcohol solvent, for example 2-propanol.

The amount of the second source of silica in the solution of step vi) of the invention is between 1 and 5 wt. % of the total solution. The amount of solvent in the solution of step vi) of the process of the invention is between 95 and 99% of the total solution. The second source of silica differs chemically from the first source of silica.

Step vi) of the process of the invention may include an impregnation step whereby the second source of silica may be impregnated into the calcined dried aged silica alumina intermediate product. Such an impregnation step may be carried out in a solvent, for example water or an alcohol solvent, for example 2-propanol. A re-slurried silica alumina is formed.

The re-slurried silica alumina is then dried as per step vii) of the process of the invention. Drying occurs at temperatures above the boiling point of the solvent i.e. if the solvent is water then a suitable drying temperature may be a temperature of between 90° C. and 120° C., preferably between 100° C. and 110° C. to form a dried re-slurried silica alumina. If the solvent is an alcohol, for example an isopropyl alcohol, then a suitable drying temperature is about 30° C. Drying is carried out at atmospheric pressure, or under suitable vacuum, or both.

The dried re-slurried silica alumina is then calcined as per step viii) of the process of the invention. Calcination of the dried re-slurried silica alumina occurs at temperatures of between 300° C. and 600° C. for 2 to 6 hours depending on the alumina source. The time and temperature parameters are independently selected. It is believed that the deposition of the second source of silica acts as an additive to stabilize the calcined dried aged silica alumina intermediate product which in turn produces a silica alumina product having higher surface area retention with less impurities. Such a process also improves the acidity of the silica alumina product.

According to a second aspect of the invention there is provided a silica alumina product produced according to the method of the invention.

According to a third aspect of the invention there is provided a silica alumina product including at least one of the following characteristics, preferably more than one of the following characteristics, and most preferably all of the following characteristics:
i) BET Surface area after calcination at 550° C. for 6 hours of below 300 m²/g, preferably below 295 m²/g;
ii) total acidity measured by NH3-TPD of above 1.80 μmol/m²; preferably above 2.00 μmol/m², and most preferably above 2.50 μmol/m²;
iii) residual surface area after calcination in air at 1200° C. for 24 hours above 30 m²/g, preferably above 50 m²/g, and most preferably above 60 m²/g; and
iv) a pore volume above 0.70 cc/g.

The methods used for measuring the various characteristics of the silica alumina product are outlined in the Analytical Techniques section hereunder.

The invention will now be described with reference to the following Figures and Examples.

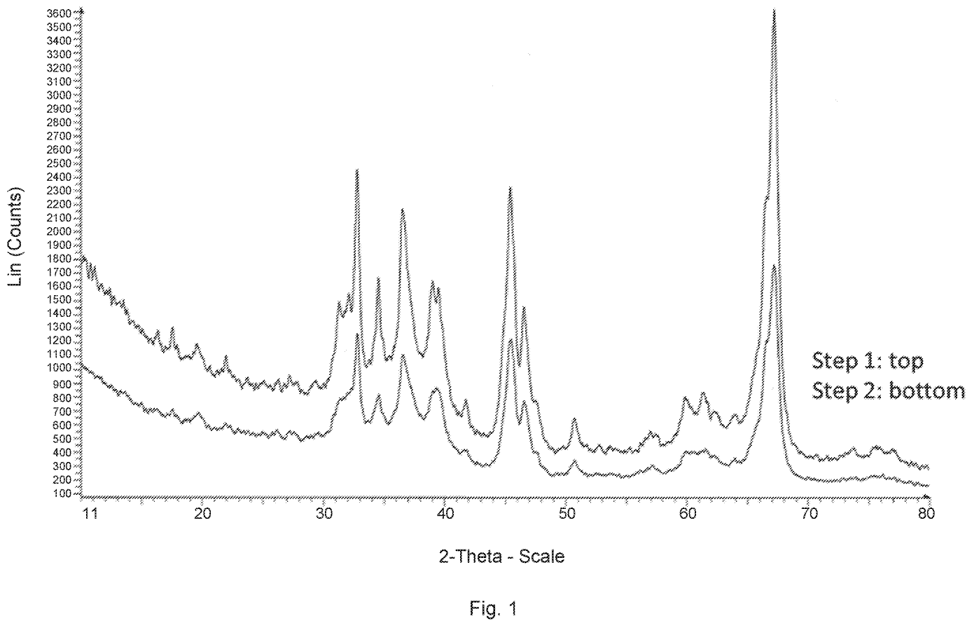

FIG. 1 is an X-ray diffraction analysis of the silica alumina powders obtained according to Example 1.

### ANALYTICAL TECHNIQUES

The properties of the product are measured by the following analytical techniques:

The chemical composition is obtained by means of ICP-AES analysis. The determination of residual carbon content on materials is carried out by means of combustion of the organic materials in the sample using a LECO analyzer apparatus. A sample of the powder is weighted in a crucible. A furnace system that operates with pure oxygen ensures complete combustion of the organic materials in the sample and gives the carbon content of the sample, expressed as % by weight.

The products are identified using X-ray analyses for the phases. The samples are placed into an XRD diameter plastic disc. XRD data is acquired. The alumina and silica and other phases are obtained comparing with referenced standards.

The silica alumina product surface area and pore volume data are both determined by N₂ adsorption and desorption isotherm. Data is collected on heat treated samples at 550° C. for 3 hours or after 1200° C. for 24 hours (Residual Surface Area or RSA). The samples are therefore degassed for 0.5 hours under N₂ flow at 300° C.

The BET surface area (m²/g) is evaluated using the B.E.T. equation.

The total pore volume is determined from the volume of nitrogen adsorbed at saturation (evaluated at relative pressure p/p₀ equal to 0.992).

NH₃-TPD is temperature program deposition which measures the total amount of acid centres (μmol/m²). The sample is calcined at 550° C. for 3 hours before analysis. Then the sample is heated at 500° C. under vacuum. The gaseous ammonia (NH₃) is allowed to adsorb at room temperature. The acidity is calculated from the total amount of adsorbed ammonia per gram of materials (mmol/g) divided by BET surface area (m²/g), the results are expressed as μmol/m² after units of measurement conversion.

### EXAMPLES

### Example 1

A weighted amount of colloidal silica solution containing a weighted amount of ammonia, at pH 9, and a nominal size of 43 Å was added to a boehmite slurry with crystal sizes (120) of 45 Å at pH of about 9 diluted with deionized water (DI water).

The resulting silica boehmite slurry was hydrothermally aged at a temperature of 130° C. for 4 hours. The aged silica boehmite slurry at the end of the run had a pH of 7. The aged silica boehmite slurry was then dried resulting in a dried, aged silica boehmite intermediate product having a crystallite size of 57 Å. The dried, aged silica boehmite intermediate product was then calcined at 550° C. for 3 hours.

The calcined dried aged silica boehmite product had a BET surface area of 291 m²/g and a pore volume of 0.74 cc/g. The total acidity measured by NH3-TPD resulted in 1.8 μmol/m².

A diluted solution of TEOS in 2-propanol (0.7 ml in 10 ml) was prepared. The calcined dried aged silica boehmite intermediate product (10 g) was added to the solution and stirred for 6 hours at room temperature to form a re-slurried silica alumina. The re-slurried silica alumina was then transferred to an open container to dry out over-night and had a residual carbon content of 0.33%. The solvent was then further extracted via vacuum at 30° C. for 2 hours to form a dried re-slurried boehmite silica with a residual carbon content of 0.11%. The dried re-slurried silica boehmite was then calcined at 550° C. for 6 hours to form a silica boehmite product.

The silica boehmite product has:
i) a BET surface area of 285 m²/g;
ii) a pore volume of 0.73 cc/g;
iii) 9% wt. SiO₂/(SiO₂+Al₂O₃);
iv) total acidity measured by NH3-TPD of 2.8 μmol/m²; and
v) after calcination in air at 1200° C. for 24 hours a residual surface area (RSA) of 71 m²/g.

### Comparative Example 1

A weighted amount of colloidal silica solution of Example 1 was added to a boehmite slurry at a pH of 9 that was diluted in DI water. The pH slightly dropped to 7. The slurry composition was hydrothermally aged at a temperature of 110° C. for 4 hours. The slurry was then spray dried resulting in a silica mixed boehmite with a crystallite size of 49 Å. The powder was calcined at 550° C. for 3 hours.

The resulting material has:
i) BET surface area of 333 m²/g;
ii) 10% wt. SiO₂/(SiO₂+Al₂O₃);
iii) after calcination in air at 1200° C. for 24 hours the residual surface area (RSA) of 26 m²/g.

The Results of Example 1 and Comparative Example 1 are summarized in Table 1:

TABLE 1

| | | Example 1 | | Comparative |
|---|---|---|---|---|
| | | Step 1 | Step 2 | Example 1 |
| SiO₂/(SiO₂ + Al₂O₃) | % wt | 6 | 9 | 10 |
| BET SA @ 550° C./3 h | m²/g | 291 | 285 | 333 |
| BET RSA@ 1200° C./24 h | m²/g | 64 | 71 | 26 |

The X-ray diffraction analysis as per FIG. 1 on the powders obtained according to the procedure of Example 1 after the addition of the second silica source, showed suppressed crystalline impurities indicating that the stability effect of the second silica source.

1. A method of making a silica alumina product including the following steps:
i) providing an alumina slurry;
ii) adding a first source of silica to the alumina slurry to form a silica alumina slurry;
iii) hydrothermally aging the silica alumina slurry to form a hydrothermally aged silica alumina slurry;
iv) drying the hydrothermally aged silica alumina slurry to form a dried, aged silica alumina intermediate product;
v) calcining the dried aged silica alumina intermediate product to form a calcined dried aged silica alumina intermediate product;
vi) adding the calcined dried aged silica alumina intermediate product from step v) to a solution including a second source of silica, the second source of silica differing chemically from the first source of silica provided in step ii) to form a re-slurried silica alumina;
vii) drying the re-slurried silica alumina to form a dried re-slurried silica alumina; and
viii) calcining the dried re-slurried silica alumina to form the silica alumina product.

2) The method of claim 1 wherein the alumina slurry includes alumina and at least water.

3) The method of claim 1 or claim 2 wherein the alumina is boehmite.

4) The method of claim 3 wherein the boehmite includes particles having a crystallite size on the (120) plane of between 40 Å and 50 Å.

5) The method of claim 1 wherein the first source of silica includes a silica sol, a precipitated silica, a fumed silica or mixtures thereof.

6) The method of claim 5 wherein the silica sol is made up of silica particles having a particle size of 40 Å to 50 Å.

7) The method of claim 1 wherein the ratio of silica to alumina in the silica alumina slurry is between 1 and 7% by weight.

8) The method of claim 1 wherein the hydrothermal aging step of step iii) occurs at temperatures between 100° C. and 150° C. for a period of 3 to 6 hours.

9) The method of claim 1 wherein the hydrothermally aged silica alumina slurry is dried at a temperature of 90 to 130° C. to form a dried, aged silica alumina intermediate product.

10) The method of claim 1 wherein the second source of silica includes SiO₂, silicon alkoxide, silicon esters, aqueous silicon compounds or mixtures thereof.

11) The method of claim 1 or claim 10 wherein the amount of the second source of silica in the solution of step vi) is between 1 and 5 wt. % of the total solution.

12) The method of claim 1 wherein step vi) of the process of the invention includes an impregnation step whereby the second source of silica is impregnated into the calcined dried aged silica alumina intermediate product to form a re-slurried silica alumina.

13) The method of claim 1 wherein calcination occurs at temperatures of between 300° C. and 600° C. for 2 to 6 hours.

14) A silica alumina product produced according to the method of claim 1.

15) A silica alumina product including at least one of the following characteristics:
i) BET Surface area after calcination at 550° C. for 6 hours of below 300 m²/g;
ii) total acidity measured by NH3-TPD of above 1.80 μmol/m²;
iii) residual surface area after calcination in air at 1200° C. for 24 hours above 30 m²/g; and
iv) a pore volume above 0.70 cc/g.
